(19) United States
(12) Patent Application Publication
(10) Pub. No.: US 2017/0186076 A1
(43) Pub. Date: Jun. 29, 2017

(54) PRODUCT TRACKING AND MANAGEMENT USING IMAGE RECOGNITION

(71) Applicant: MasterCard International Incorporated, Purchase, NY (US)

(72) Inventor: Siddique HAMEED, Chesterfield, MO (US)

(73) Assignee: MasterCard International Incorporated, Purchase, NY (US)

(21) Appl. No.: 14/981,538

(22) Filed: Dec. 28, 2015

(51) Int. Cl. G06Q 30/06; G06Q 10/08; G06K 9/00; G06Q 20/20

(52) U.S. Cl. CPC G06Q 30/0635; G06Q 20/202; G06Q 10/087; G06K 9/00664

(57) ABSTRACT

Systems and methods are provided enabling image recognition of a product for sale utilizing a consumer computing device. A product may be scanned to record an image thereof. The recorded image representative of the product is identified and a purchase transaction and/or validation of one or more aspects of the product (e.g., price, remaining stock, etc.) can be performed.

### TECHNICAL FIELD

The present disclosure is generally related to electronic transaction processing. More particularly, the present disclosure is directed to systems and methods for tracking, managing, and/or executing payment transactions based on product image recognition.

### BACKGROUND

The use of payment cards for a broad spectrum of cashless transactions has become ubiquitous in the current economy, accounting for hundreds of billions of dollars in transactions during a single year. For example, MasterCard International Incorporated, one example of a payment card network, processes upwards of 1.2 million transactions per hour across 230 countries. The use of consumer computing devices, such as smart phones, tablet personal computers (PCs), and other forms of computing devices or peripherals having powerful processing and imaging capabilities has also become ubiquitous.

### SUMMARY

In accordance with one embodiment, a method comprises scanning a product with an imaging device. The method further comprises performing image recognition on the scan of the product to identify the product, and at least one of fulfilling a purchase and validating one or more aspects of the product.

In accordance with another embodiment, a computer-implemented method comprises capturing at least one image of one or more products with an imaging device, and identifying the one or more products via image recognition performed on the at least one image of the one or more products. The computer-implemented method further comprises storing the at least one image of the one or more products with associated metadata in a point-of-sale database.

In accordance with yet another embodiment, an apparatus comprises an imaging device adapted to record an image of a product for sale, and an extraction component adapted to extract, from the recorded image, at least one descriptor describing the product for sale. Furthermore, the apparatus comprises a matching component adapted to match the at least one descriptor to at least one known descriptor associated with a known product to identify the product for sale as the known product. Moreover, the apparatus comprises at least one memory component storing computer program code, wherein the at least one memory component and stored computer program code are configured to, with the at least one processor, cause the apparatus to at least one of fulfill a purchase and validate one or more aspects of the product.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 illustrates an example payment card transaction processing system.

FIG. 2A illustrates an example payment card transaction processing system over which image recognition of products can be performed in accordance with various embodiments.

FIG. 2B illustrates the payment card transaction processing system 200 of FIG. 2A focusing on a point-of-sale (POS) terminal/system and image recognition components and interactions.

FIG. 3 is a flow chart illustrating various operations that may be performed to add products to a POS system.

FIG. 4 is a flow chart illustrating various operations that may be performed to execute payment transactions and/or product validation in accordance with various embodiments.

FIG. 5 illustrates an example computing component that may be used in implementing features of various embodiments.

The drawings are described in greater detail in the description and examples below.

### DETAILED DESCRIPTION

The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

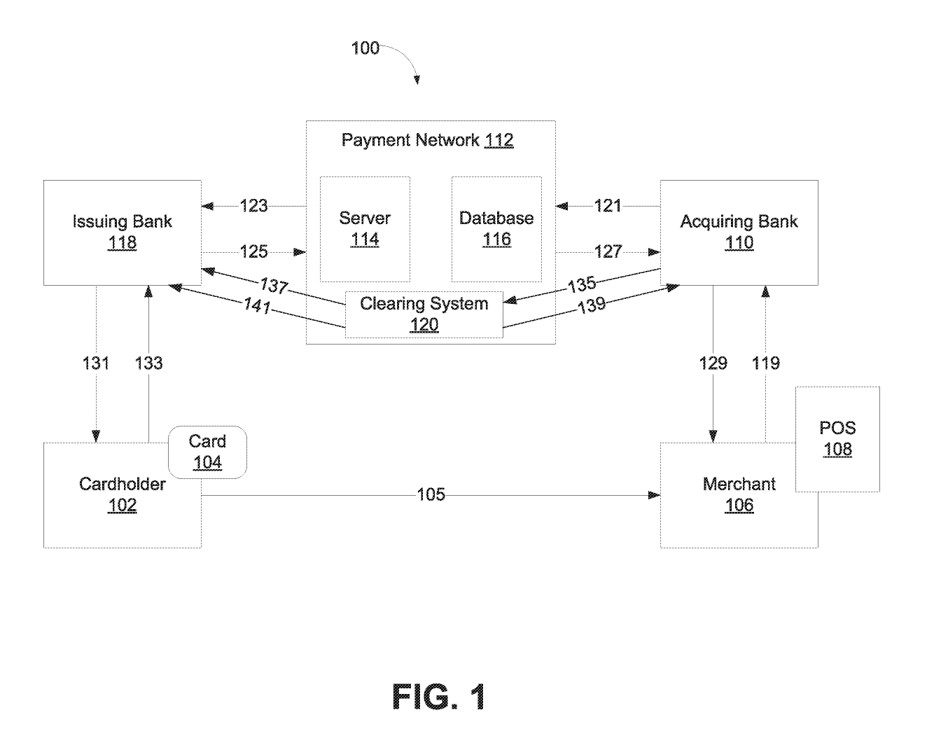

FIG. 1 depicts an example payment card transaction processing system 100 showing both the authorization side and the clearance side of card-based payments.

In a typical card-based payment system transaction, a cardholder 102 presents a credit/debit/prepaid card 104 to a merchant 106 for the purchase of goods and/or services. This transaction is indicated by arrow 105. A “card” 104, as used herein, can refer to a conventional magnetic-stripe credit, debit card, or similar proximity payment device (utilized on its own or incorporated into another device such as a mobile telephone, personal digital assistant (PDA), etc.) having near field communications (NFC) capabilities, such as a radio frequency identification (RFID) chip implemented therein. A “card” 104 can further refer to a chip-enabled “smart card,” virtual or limited use account numbers and electronic wallets.

It is understood that prior to the occurrence of such a transaction, cardholder 102 was issued card 104 by an issuing bank 118. Moreover, it will be understood that merchant 106 has established a relationship with an acquiring bank 110, thereby allowing merchant 106 to receive cards as payment for goods and/or services. That is, merchant banks and issuing banks may participate in various payment networks, including payment network 112. One such payment network is operated by MasterCard International Incorporated, the assignee of the present disclosure.

After presentation of card 104 to merchant 106 by cardholder 102, merchant 106 may send an authorization request (indicated by arrow 119) to acquiring bank 110 via a point-of sale (POS) terminal 108 located at or otherwise controlled by merchant 106. In turn, acquiring bank 110 communicates with payment network 112 (indicated by arrow 121), and payment network 112 communicates with issuing bank 118 (indicated by arrow 123) to determine whether cardholder 102 is authorized to make transaction 105. The issuing bank 118 either approves or declines the authorization request and thereafter transmits the response back to merchant 106 (indicated by arrows 125, 127 and 129). Merchant 106 may then either complete or cancel transaction 105 based upon the response to the authorization request.

If transaction 105 is approved, in accordance with processes called clearing and settlement, the transaction amount will be sent from issuing bank 118 through payment network 112 to acquiring bank 110. The transaction amount, minus certain fees, will thereafter be deposited within a bank account belonging to merchant 106. Issuing bank 118 thereafter bills cardholder 102 (indicated by arrow 131) for all transactions conducted over a given period of time by sending a cardholder statement to cardholder 102. Cardholder 102 follows by submission of payment(s) (as indicated by arrow 133) to issuing bank 118. This submission of payment(s) (as indicated by arrow 133) by cardholder 102 may be automated (e.g., in the case of debit transactions), may be initiated by cardholder 102 for the exact amount matching amounts of purchases during the statement period (e.g., charge cards or credit balances paid in full), and/or may be submitted (in part or in whole) over a period of time that thereby reflects the amount of the purchases, plus any financing charges agreed upon beforehand between cardholder 102 and issuing bank 118 (e.g., revolving credit balances).

Payment network 112 preferably includes at least one server 114 and at least one database 116. Server 114 may include various computing devices such as a mainframe, personal computer (PC), laptop, workstation or the like. Server 114 can include a processing device and be configured to implement an authorization and clearance process, which can be stored in computer storage associated with server 114. Database 116 may include computer readable medium storage technologies such as a floppy drive, hard drive, tape drive, flash drive, optical drive, read-only memory (ROM), random access memory (RAM), and/or the like. Server 114 and database 116 may be controlled by software/hardware and may store data to allow it to operate in accordance with aspects of the present disclosure.

POS terminal 108 is in data communication, directly or indirectly, and at least from time to time, with, e.g., an acquirer host computer (not shown) that is part of payment network 112 and is operated for or on behalf of acquiring bank 110, which handles payment card transactions for merchant 106. Server 114 may be operated by or on behalf of the payment network 112, and may provide central switching and message routing functions among the member financial institutions of the payment card network. Issuing bank 118 also preferably makes use of an issuer host computer (not shown), and an access point (not shown) via which the issuer host computer exchanges data messages with server 114. It should be noted that in practice, payment card transaction processing system 100 may involve a large number of cardholders, POS terminals, acquirer host computers, issuer host computers, and access points. In general, the acquirer host computer can receive authorization requests from POS terminals, forward the authorization requests through payment network 112, receive authorization responses, and relay the authorization responses to POS terminal 108. Moreover, the issuer host computer may in general, receive authorization requests from server 114 and transmit authorization responses back to server 114 with respect to the authorization requests.

It should be noted that the terms “authorization” and “authentication” may have distinct definitions in the context of electronic payment transactions. For example, the term authorization can refer to (as described above) the process by which issuing bank 118 approves or declines a transaction based on the availability of the requisite funds. Authentication can refer to the process of establishing the validity of card 104 and/or the account information associated with card 104 provided by cardholder 102. Authentication can be accomplished by manual processes, such as verifying card ownership via physical ID (e.g., driver's license) and/or by utilizing one or more fraud prevention tools, such as an address verification service (AVS), card security codes (CSS)/card verification data (CVD), card verification code (CVC2), and the like. Moreover, merchant 106 may further utilize other authentication methods or processes including certain geolocation authentication mechanisms. In the case of debit payment transactions reliant upon the use of debit cards, a personal identification number (PIN) can be used for cardholder authentication. In accordance with various embodiments, authorization and/or authentication processes can be considered to be encompassed by the exchange of authorization information (e.g., authorization request and/or authorization responses/approval/decline messaging described herein).

Also included in a typical card-based payment system transaction are the clearing and settlement processes alluded to previously and described in greater detail below.

Clearing (which can happen after transmission of the authorization response if approved) can refer to a process by which issuing bank 118 exchanges transaction information with acquiring bank 110 (also referred to as the merchant bank). Referring back to FIG. 1, acquiring bank 110 can transmit transaction information to a clearing system 120 (indicated by arrow 135). Clearing system 120 can validate the transaction information, and forward it to issuing bank 118 (indicated by arrow 137), which prepares data to be included on a payment statement for cardholder 102. Clearing system 120 may then provide reconciliation to both issuing bank 118 and acquiring bank 110 (indicated by arrows 139 and 141).

Settlement can refer to a process by which issuing bank 118 exchanges the requisite funds with acquiring bank 110 to complete an approved transaction. In particular, acquiring bank 110 may send clearing data in a clearing message to payment network 112, whereupon payment network 112 calculates a net settlement position and sends advisement to acquiring bank 110 and issuing bank 118. Issuing bank 118 can remit payment to payment network 112, which then sends the payment to acquiring bank 110. Acquiring bank 110 then pays merchant 106 for the purchase made by cardholder 102, and issuing bank 118 bills cardholder 102.

As previously alluded to, the use of consumer computing devices having powerful processing and imaging capabilities has become ubiquitous. Moreover, more and more merchants, such as merchant 106, have eschewed the use of more traditional POS terminals, such as checkout registers, in favor of such consumer computing devices, e.g., tablet PCs configured to operate like or in the place of traditional checkout registers. The use of such consumer computing devices has allowed merchants to engage in payment transaction processing without the overhead, physical space, and networking hurdles associated with conventional POS terminals. This can be useful not only for “smaller-scale” sales scenarios, e.g., mall kiosks, fairs, farmers' markets, and the like, but also for larger-scale retail establishments.

However, the processing and imaging capabilities of the aforementioned consumer computing devices has largely remained un-utilized. That is, the use of coded product indicia, such as, for example, a numeric or alpha-numeric identifier, quick-response (QR) code, stock keeping unit (SKU), universal product code (UPC), a manufacturer part number (MPN), a European article number (EAN), or an international standard book number (ISBN), or some combination thereof still exists. Accordingly, conventional POS terminals as well as consumer computing devices used as POS terminals must be configured or have added thereto, a product code scanner to scan coded product indicia, or otherwise, require manual input of product indicia when engaging in payment transaction processing. Moreover, products themselves require coding, e.g., by printing coded product indicia on a label or product packaging, manual addition of price stickers on products, etc.

In order to streamline POS and mobile POS (mPOS) terminals used in retail settings, various embodiments provide systems and methods for leveraging the processing power and imaging capabilities of consumer computing devices to enable inventory management, as well as payment transactions based on image recognition of products. Additionally, the same or similar systems and methods can be adapted for use in the context of product verification, e.g., to confirm product pricing, related product discovery, etc.

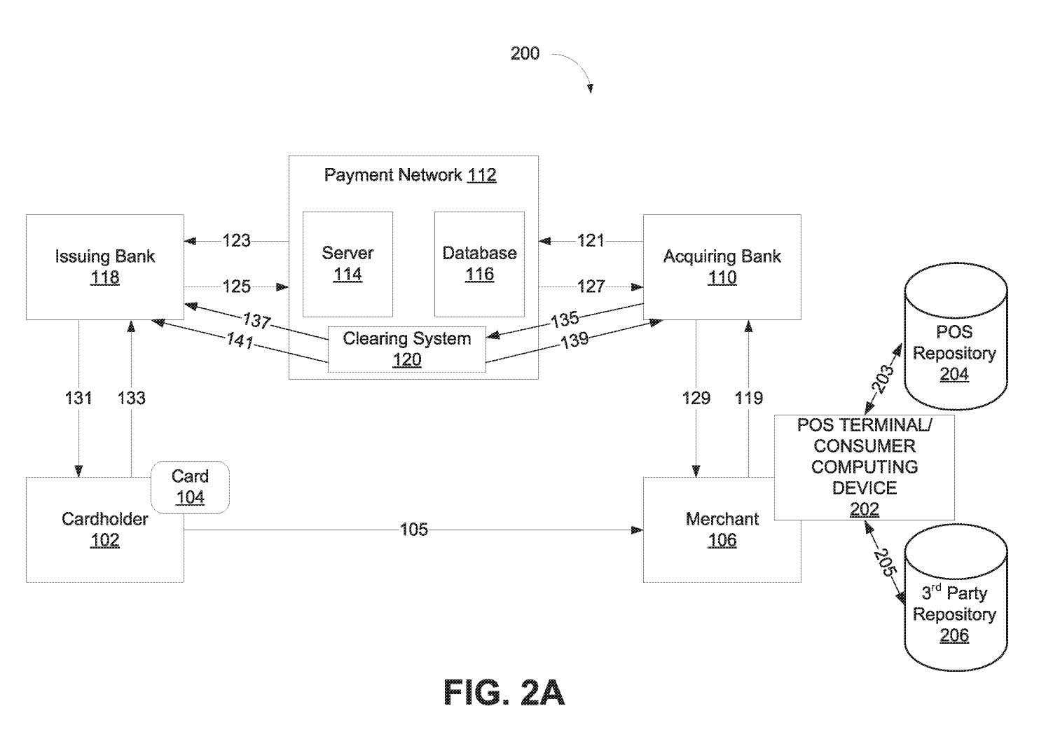

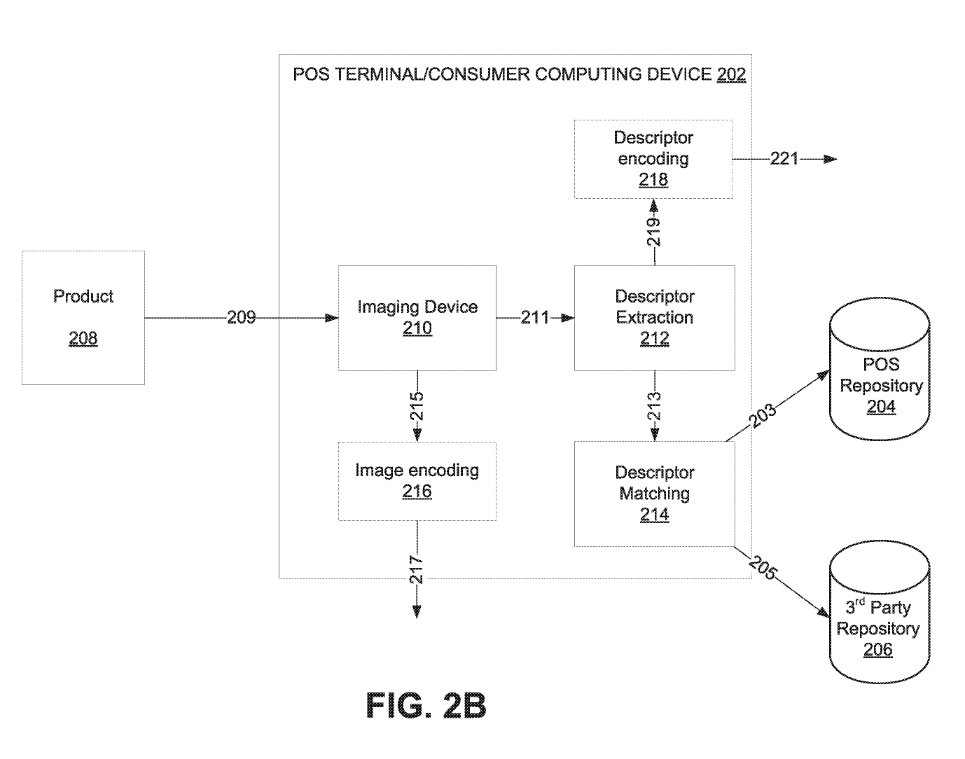

FIG. 2 illustrates an example payment card transaction processing system 200 in which image recognition may be integrated in accordance with various embodiments. Elements of system 200 may be considered to be the same or similar to like-numbered elements of FIG. 1, e.g., cardholder 102, card 104, merchant 106, acquiring bank 110, payment network 112 (and its example constituent elements), and issuing bank 118. In addition to these elements, system 200 may further product repositories, e.g., POS repository 204 and/or 3^{rd} party repository 206. These repositories may include one or more servers, processors, and/or databases that can receive, provide, store, and/or process product images. It should be noted that although FIG. 2A represents a single, centralized instances of repositories, there can be multiple repositories that may be accessed, and the repositories can be embodied as a distributed system/network of repositories, or a hybrid combination of a centralized and distributed repository.

Replacing POS 108 of FIG. 1 is POS 202, which may be one of the aforementioned consumer computing devices configured to operate as a POS terminal in accordance with various embodiments of the present disclosure. It should be noted that POS 202, may be in some embodiments, a consumer's personal computing device, such as the consumer's smart phone.

In operation, and in contrast to conventional POS terminals, POS terminal/consumer computing device 202 may be used to identify a product simply by taking a photograph or otherwise recording an image of a product, e.g., a product that a consumer wishes to purchase. POS terminal/consumer computing device 202 (in conjunction with POS repository 204) can either process the photograph or recorded image itself to identify the product represented by the photograph/recorded image, or it may transmit the photograph or recorded image to, e.g., 3^{rd} party repository 206 where product identification can occur. Upon identification of the product, pricing information can be obtained to complete the purchase. Additionally, inventory information can be updated subsequent to the purchase.

In accordance with other embodiments, image recognition can be utilized to verify, e.g., the price of a product, and/or to provide a consumer with information about the product, related products, etc. For example, a consumer may utilize a consumer computing device 202, such as a smart phone, to photograph or otherwise record an image of a product, e.g., a product for sale by merchant 106 at the merchant's location, to verify a product, e.g., obtain product pricing and/or other product-related information. It should be noted that consumer computing device 202 can be used to record an image of product/product image when the consumer is remote from the merchant 106. That is, the consumer may record an image of a product that the consumer may have previously purchased and wishes to replenish. In this instance, the recorded image may be transmitted to POS repository (associated with merchant 106) to ascertain availability of the product.

It should be noted that a payment application, such as that which can be implemented on POS terminal 202, or a product verification application, such as that which can be implemented on consumer computing device 202 may include a mechanism, e.g., an interactive graphical user interface that, in addition to capturing conventional transaction data, e.g., card data, also leverages the imaging capabilities of POS/consumer computing device 202. For example, merchant 106 may have the payment application running on POS 202, such that when a cardholder 102 wishes to purchase a product, cardholder 102 or a sales attendant may utilize the payment application to capture an image of the desired product, and purchase of the product can continue as described above with reference to FIG. 1. As another example, a consumer may utilize the product validation/verification application when the consumer is in a retail location operated by merchant 106. If the consumer wishes to obtain, e.g., pricing information, inventory information, or any other related information, such as coupons applicable to a product, the consumer can utilize the product validation application in conjunction with the imaging functionality of consumer computing device 202 to capture an image of the product so that the product can be identified and the related information retrieved and presented.

FIG. 2B illustrates POS terminal/consumer computing device 202 in greater detail as it relates to a product 208. Product 208 may be an item being sold by merchant 106, such as an article of clothing, foodstuffs, some form of equipment, etc. As illustrated in FIG. 2B, POS terminal/consumer computing device 202 may include an imaging device 210. Imaging device 210 may be an integral digital camera of a smart phone or tablet PC. Imaging device 210 may be used to capture (operation 209) a photograph or record an image of product 208. Processing may continue (operation 211) to a descriptor extraction component 212. Component 212 extracts descriptors, such as different image features, text, color, etc. of product 208 and/or image aspects surrounding or part of the captured photograph or image of product 208. Processing continues further (operation 213), where descriptor matching component 214 can be utilized to match the captured photograph or recorded image of product 208 with an image stored in POS repository 204 and/or 3^{rd} party repository 206. Matching of descriptors can involve weighted matching, where the greatest amount of descriptor matches is assumed to indicate a match between an image product 208 and a stored image, geometric verification of one or more image features, etc.

For example, cardholder 102 may wish to purchase product 208, which can be a box of cereal. Imaging device 210 may record an image of the box of cereal. Descriptors such as the name of the box of cereal, size (e.g., the number of ounces), colors of any pictures on the box of cereal, the shape of the cereal box, and the like can be gleaned from the image. These descriptors are extracted by descriptor extraction component 212. Descriptor matching component 214 then attempts to match any/all of the descriptors with those associated with an existing product, whose information is stored in at least one of POS repository 204 and 3^{rd} party repository 206. When a match is determined to exist, any metadata associated with the product, such as unit pricing, available stock, advertising, coupons, etc. may be retrieved and presented to cardholder 102 and/or the attendant of merchant 106 as well as processed by POS terminal/consumer computing device 202 to proceed with the purchase of product 208 and/or product verification of product 208.

It should be noted that POS terminal/consumer computing device 202 may further include image encoding component 216 and/or descriptor encoding component 218. These components can be utilized in the event that POS repository 204 and/or 3^{rd} party repository 206 are remotely located from POS terminal/consumer computing device 202. For example, product information may be stored in a separate repository, in which case, POS terminal/consumer computing device 202 may encode an image (operation 215) of product 208 to be transmitted to remotely located 3^{rd} party repository 206, for example, over a network, such as a wireless or wired network (operation 217). Remotely located 3^{rd} party repository 206 would then decode the encoded image, extract any descriptors, perform descriptor matching, retrieve any relevant search results and transmit them back to POS terminal/consumer computing device 202, where the results, e.g., product metadata can be presented and/or further processed, e.g., by completing a purchase transaction. POS terminal/consumer computing device 202 can additionally transmit or relay counts of purchased products or otherwise update one or more inventory data repositories associated with merchant 106. Such inventory data repositories can be incorporated into, e.g., POS repository 204, where product identification information and metadata can be maintained in conjunction with appropriate inventory data. It should be noted that various embodiments disclosed in the present disclosure can be applied to any product tracking and/or management context besides just completing purchase transactions and maintaining inventory. That is, any process involving, e.g., products for sale, can be enhanced through the use of image recognition to identify such products rather than relying on conventional systems and methods of tracking and managing products/inventory, such as by the aforementioned UPC, QR, etc. techniques.

In accordance with another embodiment, descriptor encoding component 218 may encode any extracted descriptors (operation 219) obtained by descriptor extraction component 212 from an image representative of product 208. The encoded descriptors may be transmitted over a network, e.g., wireless or wired network (operation 221), to remotely located POS repository 204. Remotely located POS repository 204 then performs descriptor decoding, matching, and searching, whereupon any search results are transmitted over the network back to POS terminal/consumer computing device 202, where the results, e.g., product metadata can be presented and/or further processed, e.g., by completing a purchase transaction.

It should be noted that the above-described methods of image recognition/visual product searching are merely examples, and not meant to limiting in any way. Other systems and methods of image recognition/visual searching can be utilized in conjunction with the above-described systems and methods or as alternatives to the above-described systems and methods.

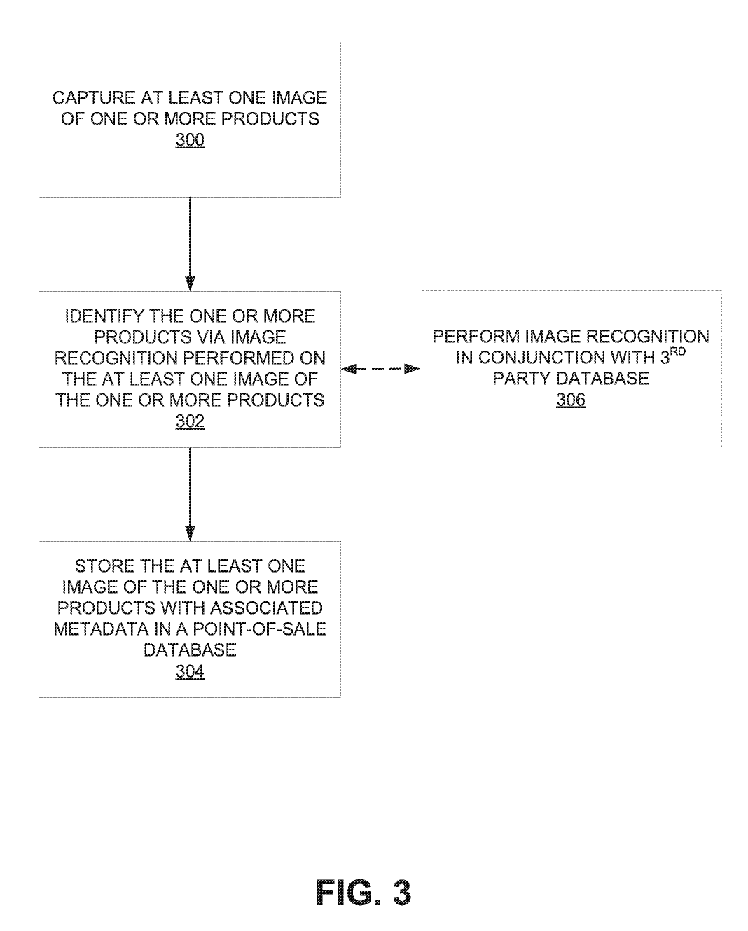

FIG. 3 illustrates a flow chart describing various processes that can be performed in order to add products into a merchant's POS system using image recognition. At operation 300, at least one image of one or more products to be sold or otherwise distributed by merchant 106 is captured. Imaging device 210 of POS terminal 202 can be used to capture such images. Multiple images can be captured and associated with a single product in order to capture images from, e.g., various perspectives, to make for a more robust descriptor matching process. Additionally, multiple (e.g., related) products can be identified with a single/single set of images. At operation 302, the one or more products are identified via image recognition performed on the at least one image of the one or more products. One or more image recognition algorithms can be used to uniquely identify each of the one or more products. Descriptors such as physical characteristics, appearance (shape, size, color, texture, text, label(s), etc.) can relied upon to identify each product. At operation 304, the at least one image of the one or more products is stored with associated metadata in a POS database, such as POS repository 204. As an optional operation (operation 306), image recognition of the one or more products can be performed in conjunction with a 3^{rd} party database, such as 3^{rd} party repository 206. That is, any existing product repositories may be leveraged as an alternative to or in conjunction with the storage and maintenance of a merchant-specific product repository.

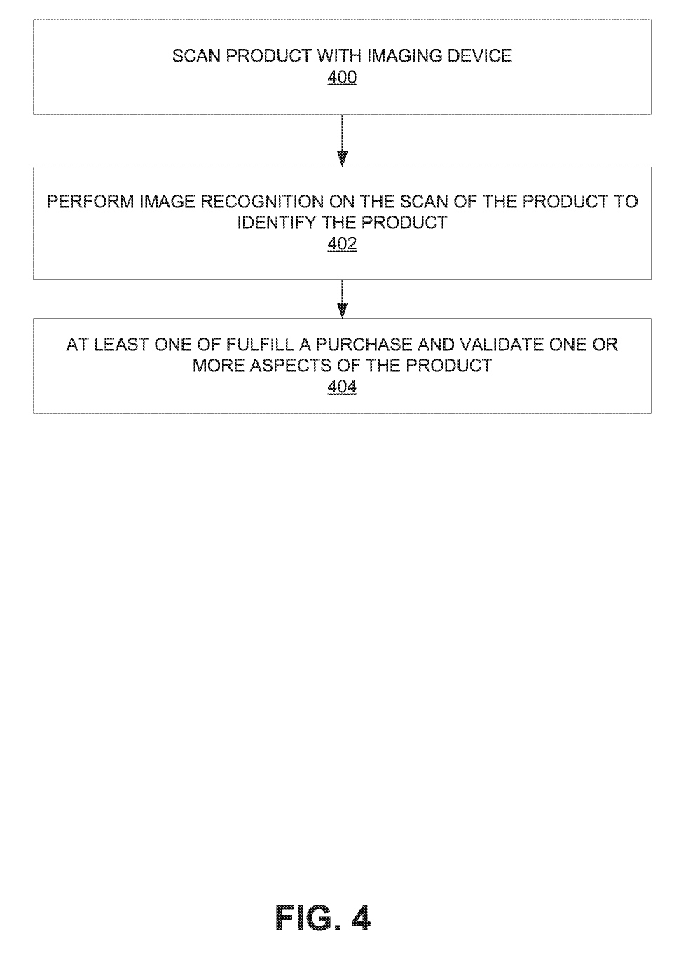

FIG. 4 illustrates a flow chart describing various processes that can be performed in order to effectuate a purchase transaction using image recognition of a product. At operation 400, a product is scanned with an imaging device. As described previously, the imaging device, can be an integral digital still/video camera, webcam, or other imaging device of POS terminal/consumer computing device 202. At operation 402, image recognition is performed on the scan of the product to identify the product. For example, descriptor extraction 212 can be applied to a captured image of the product (scanned product) to obtain one or more image features or descriptors that can be utilized to identify the product by matching the one or more image features of descriptors to those of known/identified products. The descriptor matching 214 can be accomplished by POS terminal/consumer computing device 202 in conjunction with a co-located POS repository 204 or a remotely located POS repository 204/3^{rd} party repository 206. At operation 404, at least one of fulfilling a purchase or validating/verifying one or more aspects of the scanned product can be performed. That is, after obtaining relevant information regarding the scanned product, e.g., price, remaining stock, etc., and the relevant information is transmitted to the POS terminal/consumer computing device 202, the product can be purchased and paid for or validated.

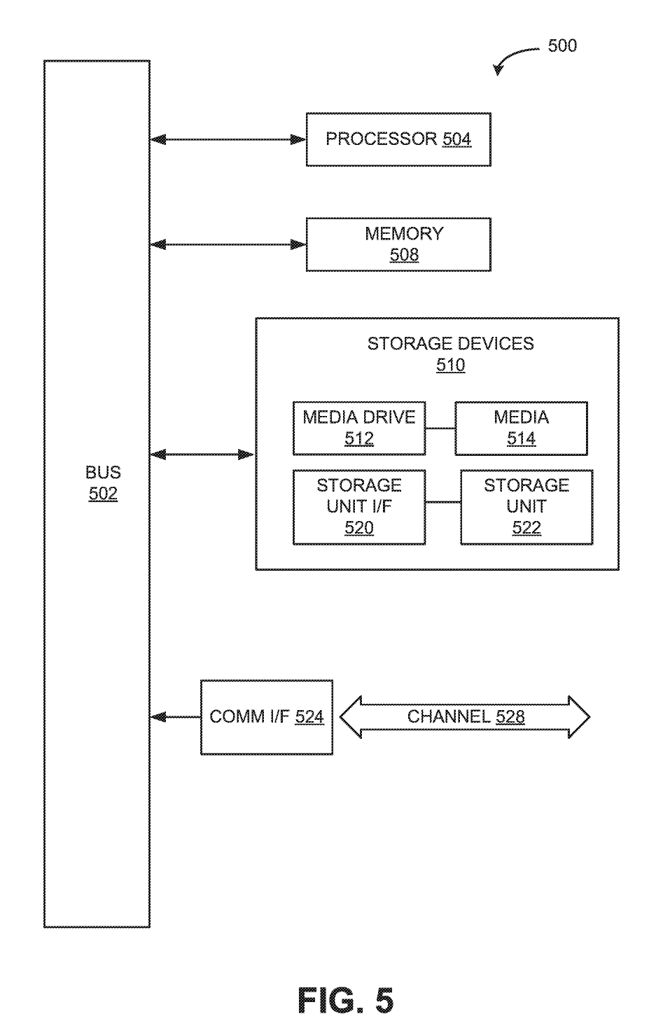

FIG. 5 illustrates an example computing component 500, an example of which may be a processor/controller resident on a consumer computing device or POS terminal, or a processor/controller used to operate a consumer computing device or POS terminal, that may be used to implement various features and/or functionality of the systems and methods disclosed in the present disclosure.

As used herein, the term component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. In implementation, the various components described herein might be implemented as discrete components or the functions and features described can be shared in part or in total among one or more components. In other words, as would be apparent to one of ordinary skill in the art after reading this description, the various features and functionality described herein may be implemented in any given application and can be implemented in one or more separate or shared components in various combinations and permutations. Even though various features or elements of functionality may be individually described or claimed as separate components, one of ordinary skill in the art will understand that these features and functionality can be shared among one or more common software and hardware elements, and such description shall not require or imply that separate hardware or software components are used to implement such features or functionality.

Where components or components of the application are implemented in whole or in part using software, in one embodiment, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, digital cameras, navigation systems, cellular telephones, portable computing devices, modems, routers, WAPs, terminals and other electronic devices that might include some form of processing capability.

Computing component 500 might include, for example, one or more processors, controllers, control components, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing component 500 or to communicate externally.

Computing component 500 might also include one or more memory components, simply referred to herein as main memory 508. For example, preferably random access memory (RAM) or other dynamic memory might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage devices 510, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), or other removable or fixed media drive might be provided. Accordingly, storage media 514 might include, for example, a hard disk, a floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage devices 510 might include other similar instrumentalities for allowing computer programs or other instructions or data to be loaded into computing component 500. Such instrumentalities might include, for example, a fixed or removable storage unit 522 and a storage unit interface 520. Examples of such storage units 522 and storage unit interfaces 520 can include a program cartridge and cartridge interface, a removable memory (for example, a flash memory or other removable memory component) and memory slot, a PCMCIA slot and card, and other fixed or removable storage units 522 and interfaces 520 that allow software and data to be transferred from the storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 508, storage unit interface 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the components or functionality described or claimed as part of the component are all configured in a common package. Indeed, any or all of the various components of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
scanning a product with an imaging device;
performing image recognition on the scan of the product to identify the product; and
at least one of fulfilling a purchase and validating one or more aspects of the product.

2. The method of claim 1, wherein the performance of the image recognition comprises extracting descriptors from the scan of the product.

3. The method of claim 2, wherein the performance of the image recognition further comprises matching the extracted descriptors with known descriptors associated with a known product.

4. The method of claim 3, wherein the performance of the image recognition further comprises identifying the product as the known product.

5. The method of claim 1, further comprising identifying at least one associated aspect of the product including price of the product and product inventory.

6. The method of claim 5, wherein the fulfillment of the purchase comprises initiating and completing a payment transaction with a payment network based upon the price of the product.

7. The method of claim 6, further comprising updating the product inventory based upon the completed payment transaction.

8. The method of claim 5, wherein the validation of the one or more aspects of the product comprises presenting at least one of the price of the product and the product inventory on a consumer computing device prior to fulfilling the purchase of the product.

9. A computer-implemented method, comprising:
capturing at least one image of one or more products with an imaging device;
identifying the one or more products via image recognition performed on the at least one image of the one or more products; and
storing the at least one image of the one or more products with associated metadata in a point-of-sale database.

10. The computer-implemented method of claim 9, wherein the identification of the one or more products comprises identifying the one or more products based upon at least one of physical characteristics and appearance of the one or more products captured in the at least one image.

11. The computer-implemented method of claim 9, wherein the identification of the one or more products comprises matching the at least one of the physical characteristics and the appearance of the one or more products with at least one of physical characteristics and appearance associated with one or more known products maintained in a third party database.

12. The computer-implemented method of claim 9, further comprising receiving an image of a to-be-purchased product via a point-of-sale terminal.

13. The computer-implemented method of claim 12, further comprising performing image recognition on the received image to identify the to-be-purchased product among the one or more products stored with associated metadata in the point-of-sale database.

14. The computer-implemented method of claim 13, further comprising initiating a payment transaction to purchase the to-be-purchased product based on the associated metadata, the associated metadata comprising at least a price associated with the to-be-purchased product.

15. The computer-implemented method of claim 9, further comprising receiving an image of a to-be-validated product via a consumer computing device.

16. The computer-implemented method of claim 15, further comprising performing image recognition on the received image to identify the to-be-validated product among the one or more products stored with associated metadata in the point-of-sale database.

17. The computer-implemented method of claim 16, further comprising initiating a validation procedure for the to-be-validated product, the validation procedure comprising retrieving the associated metadata, the associated metadata comprising at least one a price of the to-be-validated product and remaining inventory of the to-be-validated product.

18. An apparatus, comprising:
an imaging device adapted to record an image of a product for sale;
an extraction component adapted to extract, from the recorded image, at least one descriptor describing the product for sale;
a matching component adapted to match the at least one descriptor to at least one known descriptor associated with a known product to identify the product for sale as the known product; and
at least one memory component storing computer program code, wherein the at least one memory component and stored computer program code are configured to, with the at least one processor, cause the apparatus to at least one of fulfill a purchase and validate one or more aspects of the product.

19. The apparatus of claim 18, wherein the apparatus comprises a consumer computing device adapted to operate as a point-of-sale device.

20. The apparatus of claim 18, wherein the stored computer program code, with the at least one processor, causing the apparatus to at least one of fulfill the purchase and validate the one or more aspects of the product further causes the apparatus to retrieve metadata associated with the known product such that the at least one of the fulfillment of the purchase and the validation of the one or more aspects of the product is achieved based on the retrieved metadata, the retrieved metadata comprising at least a price associated with the known product.
